(19) United States
(12) Patent Application Publication
(10) Pub. No.: US 2013/0263044 A1
(43) Pub. Date: Oct. 3, 2013

(54) METHOD AND SYSTEM TO PROVIDE A SCROLL MAP

(71) Applicants: Matthew Bret MacLaurin, Santa Cruz, CA (US); Jai Dandekar, San Jose, CA (US); Hsin-yi Chien, Cupertino, CA (US); Bhanu Koppaka, San Jose, CA (US); Naren Chittar, San Jose, CA (US); John Sheeley, San Francisco, CA (US); Govind Kaushal, San Jose, CA (US)

(72) Inventors: Matthew Bret MacLaurin, Santa Cruz, CA (US); Jai Dandekar, San Jose, CA (US); Hsin-yi Chien, Cupertino, CA (US); Bhanu Koppaka, San Jose, CA (US); Naren Chittar, San Jose, CA (US); John Sheeley, San Francisco, CA (US); Govind Kaushal, San Jose, CA (US)

(73) Assignee: eBay Inc., San Jose, CA (US)

(21) Appl. No.: 13/725,395

(22) Filed: Dec. 21, 2012

Related U.S. Application Data
(60) Provisional application No. 61/618,122, filed on Mar. 30, 2012.

(51) Int. Cl. G06F 3/0485

(52) U.S. Cl. CPC G06F 3/04855
USPC 715/786

(57) ABSTRACT

Method and system to provide a scroll map are described. A system to provide a scroll map includes a scroll presentation module, a selection module, and a bookmarking module. The scroll presentation module may be configured to present search results as a scroll presentation. The selection module may be configured to identify a certain listing from the search results in response to a selection request. The bookmarking module may be configured to display a marker associated with the selected listing directly on the scroll bar.

### CROSS-REFERENCE TO RELATED APPLICATIONS

This application claims the benefit of U.S. Provisional Application No. 61/618,122, filed Mar. 30, 2012, entitled “METHOD AND SYSTEM TO PROVIDE A SCROLL MAP,” which is incorporated herein by reference in its entirety.

### TECHNICAL FIELD

This application relates to a method and astern to provide a scroll map.

### BACKGROUND

An on-line trading platform allows users to shop for almost anything using a web browser application. A user may find an item listed by an on-line trading application by entering keywords into the search box provided on an associated web page or by browsing through the list of categories on the home page. After a list of search results is returned, a user may further refine a search using a list of filters provided in the right-side portion of the search results web page. A user may select an item from the search results to view the details of the item. A user may then return to the search results page to further refine the search by using filters provided in the right-side portion of the search results web page.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a network diagram depicting a client-server system, within which one example embodiment may be deployed;

FIG. 2 is a block diagram of a system to provide a scroll map of search results, in accordance with one example embodiment;

FIG. 3 is a flow chart of a method to provide a scroll map of search results, in accordance with an example embodiment;

FIG. 4 shows an example scroll presentation, in accordance with an example embodiment;

FIG. 5 shows an example user interface to display a thumbnail image of a bookmarked listing, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

A method and to provide a scroll map of search results in the context of on-line trading is described. In the following description, for purposes of explanation, numerous specific details are set forth in order to provide a thorough understanding of an embodiment of the present invention. It will be evident, however, to one skilled in the art that the present invention may be practiced without these specific details. Embodiments of the present invention include approaches that enhance user's experience by permitting a user to quickly identify previously selected items presented as an ‘infinite’ scrollable list.

In one embodiment, in response to a search request, e.g., with respect to listings accessible in the context of an on-line trading platform, the search results are displayed in the form of a scrollable list of items that satisfy the search criteria. A user may scroll through the items (listings) presented in the scrollable list and select one or more items that may be of interest or for future reference. The selection in this scenario may be referred to as bookmarking or tagging. As the user bookmarks an item in the scrollable list, a marker (also referred to as an annotation) appears on the scroll bar. The effect of such bookmarking is what may be termed a scroll map of the tagged/marked listings, as the user can follow the marks on the scroll bar to faster access or preview those items that she previously marked as being of potential interest. This technique may be particularly beneficial when the scrollable list contains a great number of items.

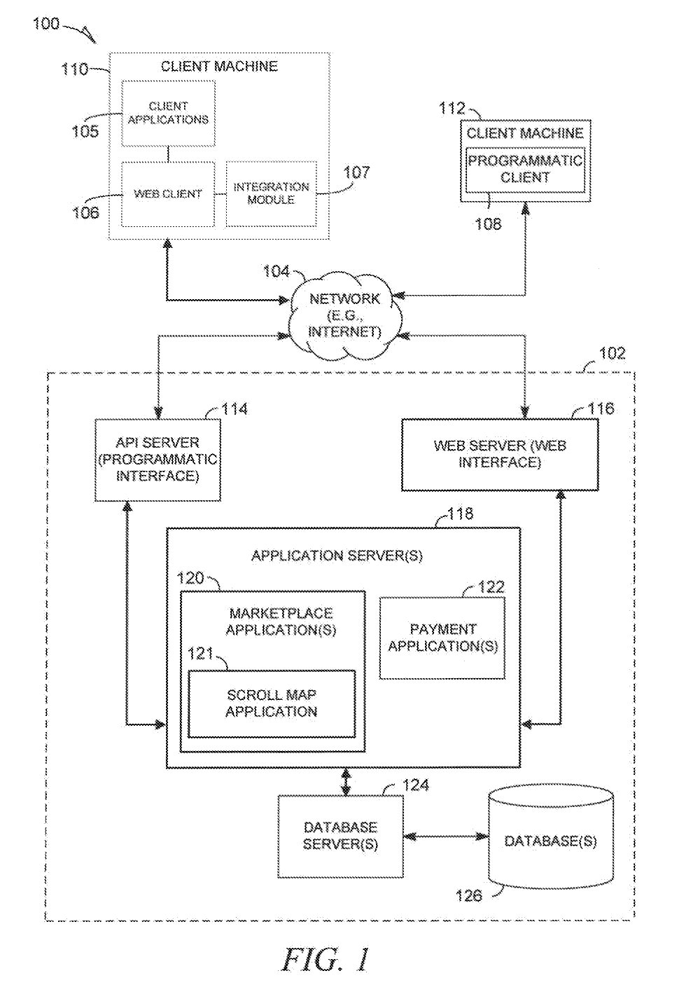

It will be noted, that, while some embodiments are being described with reference to search results comprising item listings in the context of an on-line trading, platform, the techniques described herein may be used beneficially with respect to displaying any scrollable list, where a user is permitted to select and bookmark/tag items from the list. Example method and system to provide to scroll map of search results in the context of on-line trading may be implemented in the context of a network environment 100 illustrated in FIG. 1, specifically as a scroll map application 121.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, client applications 105 (e.g., mobile applications), an integration module 107, and a web client 106 (e.g., a mobile or desktop Web browser) operating on the client machine 110 (e.g., a mobile device), as well as a programmatic client 108 operating on the client machine 112.

An application Program Interface (API) server 114 and a web server 116 are coupled to and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. Shown in FIG. 1 is a scroll map application 121 included as one of the marketplace applications 120. The scroll map application 121 may be utilized beneficially to present information markers on the scroll bar portion of a scrollable presentation of information items and also provide a preview of marked items.

In one example embodiment, as mentioned above, a scrollable presentation of information items may be a list of search results provided in response to a search request in the context of an on-line trading platform. As a user scrolls through the search results, e.g., using an ‘infinite’ scroll where no pages are required, a scroll map system (e.g., the scroll map application 121 of FIG. 1) permits the user to select and mark those listings from the search results that may be of further interest to the user. In one embodiment, the markers/tags indicative of the user's selection are displayed directly on the scroll bar, such that it makes it easier for the user to quickly jump back and forth between the marked items. The user may select an item to be marked, e.g., by clicking on an item in the scrollable presentation of the search results. Respective distances between the markers created on the scroll bar are presented as scaled, based on the number of items that have been scrolled through. For example, as the number of scrolled-through items increases, the markers in the scroll bar associated with the bookmarked items appear closer together. In one embodiment, a user can use a pointing device (e.g., a mouse) to hover over markers that have been placed onto the scroll bar to see thumbnail images of the tagged item listings. The scroll map system 121 may be configured to offer an option to perform a “more like these” new search using one or more attributes from the bookmarked item listings. The marked item listings may be saved by a user for later reference.

Returning to FIG. 1, the payment applications 122 may provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 107.

Further, while the system 100 shown in FIG. 1 employs client-server architecture, the subject matter of the application is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc,. of San Jose, Calif.) to enable sellers to author and manage listings on the networked system 102 in an off-line manner, and to perform batch-mode communications between the programmatic client 108 and the networked system 102.

The integration module 107 on the diem machine (e.g., a mobile phone) may submit requests to the marketplace applications 110, through the API server 114, for an up-to-date (e.g., current) publication related to goods and/or services being offered for sale via the networked system 102. A publication related to goods and/or services being offered for sale may also be termed an item listing. Alternatively or additionally the client machine 110 may request one or more current publications from the client machine 112, via the network 104, in various example embodiments, the client machine 112 may provide a current publication to the client machine 110, after generating the current publication or retrieving such as publication from the networked system 102.

In some example embodiments, the integration module is embedded within one or more of the client applications 105 and may collect user parameters, receive targeted current publications based on the user parameters, and cause the display of one or more targeted current publications. A targeted current publication may be displayed among graphics associated with the application in which the integration module is embedded.

The applications 120, including the scroll map application 121, may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or service.

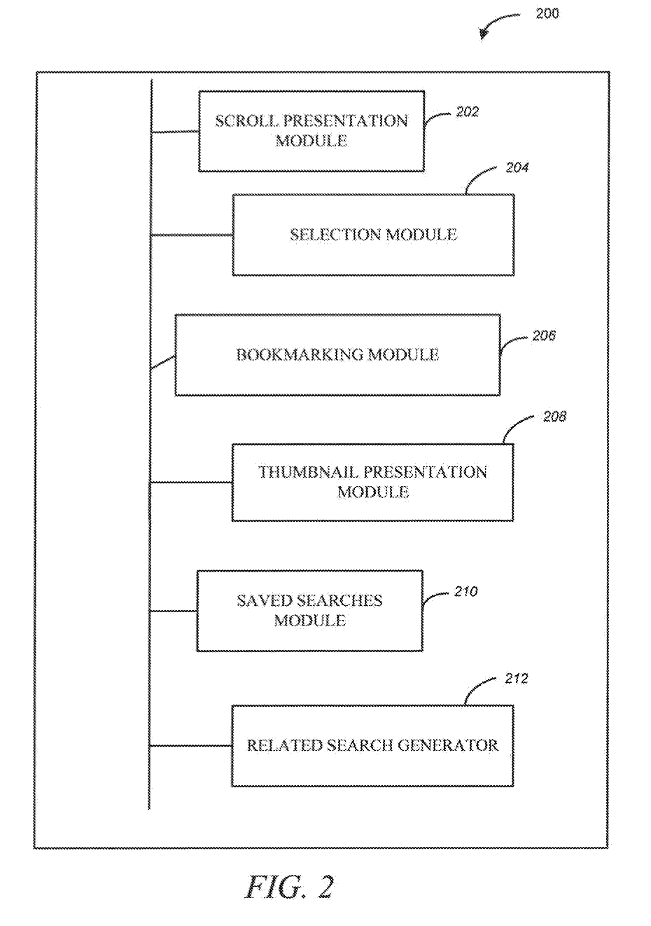

FIG. 2 is a block diagram of a system 200 to provide a scroll map, in accordance with one example embodiment. As shown in FIG. 2, the system 200 includes a scroll presentation module 202, a selection module 204, and a bookmarking module 206. The scroll presentation module 202 may be configured to present, on a display device, search results as a scroll presentation. The scroll presentation comprises a search results area for displaying search results and a scroll bar for scrolling through the search results. As mentioned above, the search results comprising items representing respective listings. The selection module 204 may be configured to identify a certain listing from the search results in response to a selection request associated with the certain listing. The bookmarking module 206 may be configured to display a marker associated with the selected listing directly on the scroll bar. As mentioned above, the scroll presentation may be in the form of an “infinite” scroll bar that permits navigating through search results without using pagination. The bookmarking module 206 may also be configured to display markers on the scroll bar spaced in a manner indicative of a number of listings in the search results that have been scrolled through, such that two markers are positioned closer together as a number of scrolled-through listings increases.

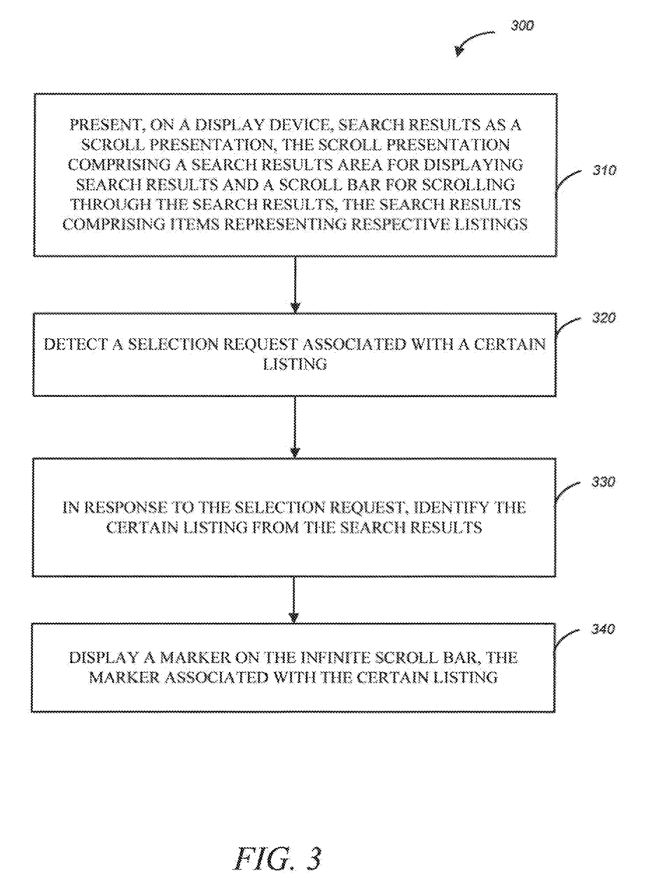

Also shown in FIG. 2 is a thumbnail presentation module 208. The thumbnail presentation module 208 may be configured detect an event associated with the selected listing, e.g., a hover of a pointing control, and present a thumbnail image of an item associated with the listing, over which the pointing control is hovering. The system 200 may also include a saved searches module 210. The saved searches module 210 may be configured to generate a list of saved searches comprising listings from the search results that are associated with respective markers on the scroll bar. As mentioned above, a user may be presented with an option to perform a search intended to produce further results that are similar to the bookmarked items. A related search generator 212 may be configured to present an option to perform such new search. Such new search may be generated by the search generator 212 using one or more attributes of the selected/bookmarked listing. An example method to provide a scroll map can be described with reference to FIG. 3.

FIG. 3 is as flow chart of a method 300 to provide a scroll map, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 118 of FIG. 1 and, specifically, at the system 200 shown in FIG. 2.

As shown in FIG. 3, the method 300 commences at operation 310, when the scroll presentation module 202 of FIG. 2 presents, on a display device, search results as a scroll presentation that comprises a search results area for displaying search results and a scroll bar for scrolling through the search results. At operation 320, a selection request associated with a listing from the search results is detected, and the selection module 204 identifies a listing from the search results at operation 330. The bookmarking module 206 of FIG. 2 displays a marker associated with the selected listing directly on the scroll bar, at operation 340. As mentioned above, the markers on the scroll bar may be spaced in a manner indicative of a number of listings in the search results that have been scrolled through, such that two markers are positioned closer together as a number of scrolled-through listings increases.

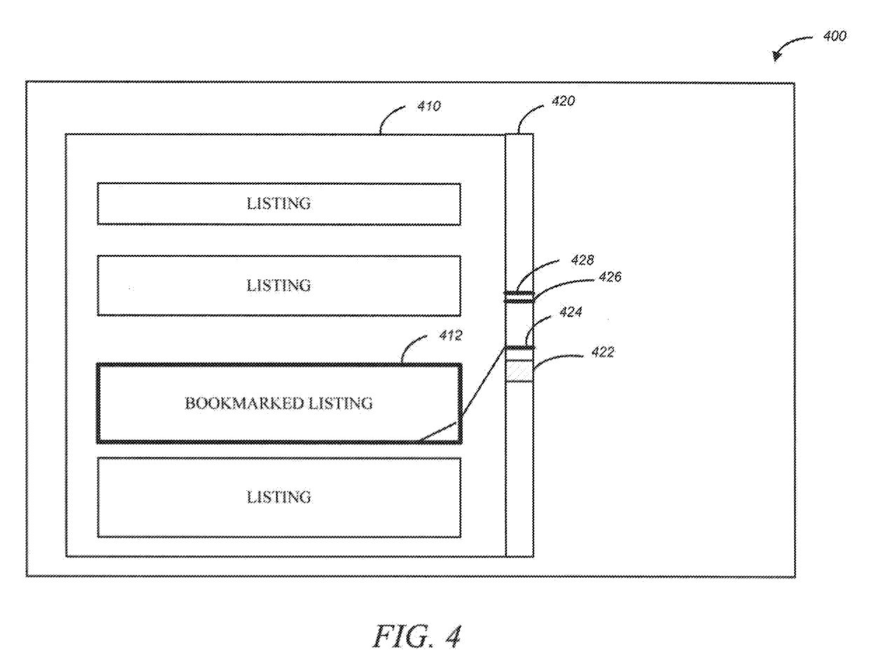

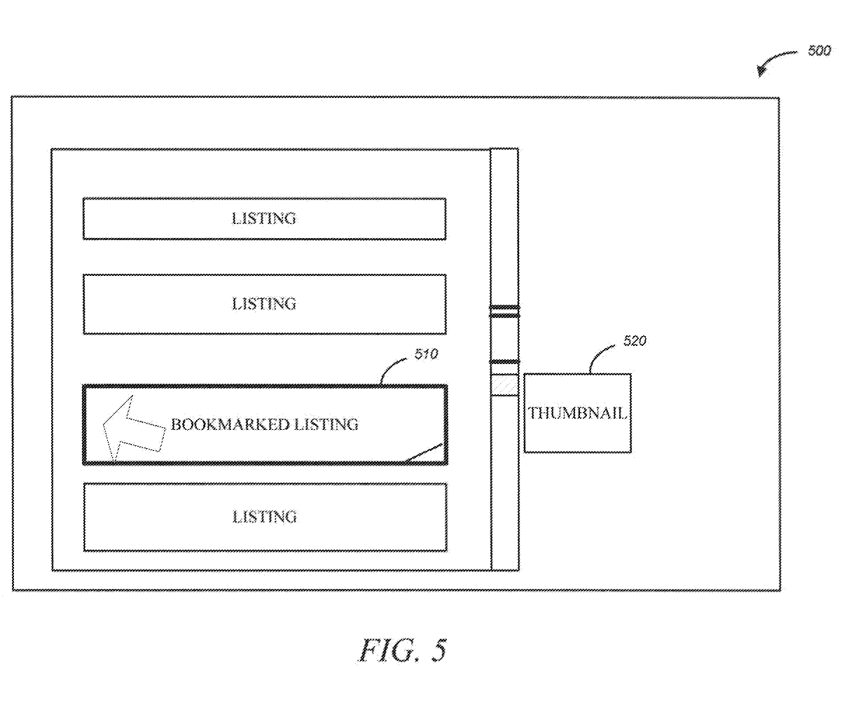

An example scroll presentation 400 is illustrated in FIG. 4. As shown in FIG. 4, the scroll presentation 400 comprises a search results area 410 and a scroll bar 420. The listing 412 is shown with a thicker border to indicate that it has been selected by a user and bookmarked by the system 200 of FIG. 2. The scroll bar 420 comprises a scroll box 422, and markers 424, 426, and 428. The marker 424 is associated with the position of the listing 412 in the search results list. FIG. 5 shows an example user interface 500 to display a thumbnail image 520 of a bookmarked listing 510, in accordance with an example embodiment.

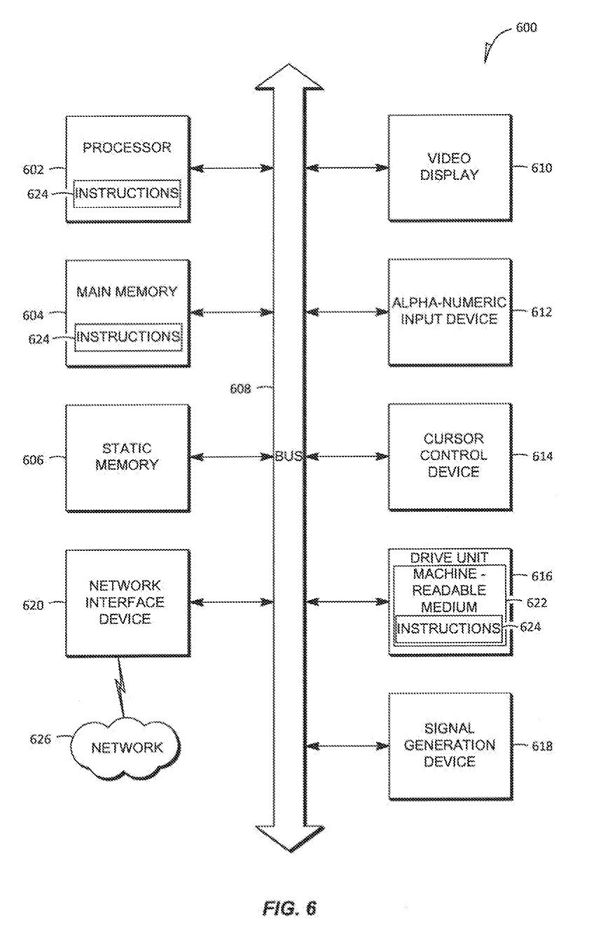

FIG. 6 is a diagrammatic representation of a machine in the example form of a computer system 500 within which is set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing in a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 606. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a cursor control device), a disk drive unit 616, a signal generation device 618 (e.g., a speaker) and a network interface, device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a no transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as is hardware-implemented module that operates to perform certain operations as described herein.

In various embodiments, a hardware-implemented module may be implemented mechanically or electronically. For example, a hardware-implemented module may comprise dedicated circuitry or logic that is permanently configured as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure is processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicative coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service”s (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to provide a scroll map have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
at least one processor coupled to a memory;
a scroll presentation module to present, on a display device, using at least one processor, search results as a scroll presentation, the scroll presentation comprising a search results area for displaying search results and a scroll bar for scrolling through the search results, the search results comprising items representing respective listings;
a selection module to identify, using at least one processor, a certain listing from the search results in response to a selection request associated with the certain listing; and
a bookmarking module to display, using at least one processor, a plurality of markers on the scroll bar, markers form the plurality of markers associated with respective selected listings from the search results, wherein the bookmarking module is to display the plurality of markers on the scroll bar spaced in a manner indicative of a number of listings in the search results that have been scrolled through.

2. The system of claim 1, wherein the scroll presentation permits navigating through search results in the search results area using the scroll bar without using pagination.

3. (canceled)

4. (canceled)

5. The system of claim 4, wherein the bookmarking module is to display two markers from the plurality of markers closer together as a number of scrolled-through listings increases.

6. The system of claim 1, comprising a thumbnail presentation module to, using at least one processor:
detect an event associated with the selected listing; and
present, on the display device, a thumbnail image of an item associated with the selected listing.

7. The system of claim 6, wherein the event is associated with a hover over the selected listing in the search results area.

8. The system of claim 11 comprising a saved searches module to, using at least one processor:
detect a save request; and
in response to the save request, generate a list of saved searches, the list of saved searches comprising listings from the search results that are associated with respective markers on the scroll bar.

9. The system of claim 1, comprising a related search generator to present, using at least one processor, on the display device, an option to perform a new search, the new search to produce results similar to the selected listing.

10. The system of claim 9, wherein the related search generator is to generate the new search using one or more attributes of the selected listing.

11. A method comprising:
presenting, using at least one processor, on a display device, search results as a scroll presentation, the scroll presentation comprising a search results area for displaying search results and a scroll bar for scrolling through the search results, the search results comprising items representing respective listings;
in response to a selection request, identifying, using at least one processor, a selected listing from the search results;
displaying a plurality of markers on the scroll bar, markers form the plurality of markers associated with respective selected listings from the search results, wherein the bookmarking module is to display the plurality of markers on the scroll bar spaced in a manner indicative of a number of listings in the search results that have been scrolled through.

12. The method of claim 11, wherein the scroll presentation permits navigating through search results in the search results area using the scroll bar without using pagination.

13. The method of claim 11, comprising displaying a plurality of markers on the scroll bar, markers form the plurality of markers associated with respective selected listings from the search results.

14. The method of claim 13, wherein the displaying of the plurality of markers on the scroll bar comprises presenting the plurality of markers spaced in a manner indicative of a number of listings in the search results that have been scrolled through.

15. The method of claim 14, wherein the displaying of the plurality of markers on the scroll bar comprises presenting two markers from the plurality of markers closer together as a number of scrolled-through listings increases.

16. The method of claim 11, comprising:
detecting an event associated with the selected listing; and
presenting, on the display device, a thumbnail image of an item associated with the selected listing.

17. The method of claim 16, wherein the event is associated with a hover over the selected listing in the search results area.

18. The method of claim 11, comprising:
detecting a save request; and
in response to the save request, generating a list of saved searches, the list of saved searches comprising listings from the search results that are associated with respective markers on the scroll bar.

19. The method of claim 11, comprising:
based on respective attributes of selected listings from the search results, generating a new search criteria; and
presenting, on the display device an option to perform a new search using the new search criteria.

20. A machine-readable non-transitory storage medium having instruction data to cause a machine to:
present, on a display device, search results as a scroll presentation, the scroll presentation comprising a search results area for displaying search results and a scroll bar for scrolling through the search results, the search results comprising items representing respective listings;
identify a certain listing from the search results in response to a selection request associated with the certain listing; and
display a plurality of markers on the scroll bar, markers form the plurality of markers associated with respective selected listings from the search results, wherein the bookmarking module is to display the plurality of markers on the scroll bar spaced in a manner indicative of a number of listings in the search results that have been scrolled through.
